(19) United States
(12) Patent Application Publication
(10) Pub. No.: US 2012/0231943 A1
(43) Pub. Date: Sep. 13, 2012

(54) METHOD OF MANUFACTURING FLUORINE-CONTAINING OPTICAL FIBER BASE MATERIAL AND FLUORINE-CONTAINING OPTICAL FIBER BASE MATERIAL

(75) Inventor: Yuhei URATA, Gunma (JP)

(73) Assignee: SHIN-ETSU CHEMICAL CO., LTD., Tokyo (JP)

(21) Appl. No.: 13/414,731

(22) Filed: Mar. 8, 2012

(30) Foreign Application Priority Data
Mar. 10, 2011 (JP) 2011-052634

(51) Int. Cl. C03C 13/04; C03B 37/012

(52) U.S. Cl. 501/37; 65/397

(57) ABSTRACT

A method of manufacturing a fluorine-containing optical fiber base material through a sintering process includes dehydrating a porous glass stack by heating it under a chlorine-based gas atmosphere, adding fluorine into the porous glass stack by heating it under a fluorine source gas atmosphere, and making the porous glass stack transparent by heating it under a fluorine source gas atmosphere at a higher temperature than a temperature at which the porous glass stack is heated in the adding. Here, process temperatures in the dehydrating, adding and making are T₁, T₂ and T₃ (K) respectively, concentrations of the fluorine source gas in the adding and making are C₂ and C₃ (%) respectively, a parameter Q is represented by the formula: Q=C₂×exp(−T₂/T₁)+C₃×exp(−T₂/T₁), and the process temperatures and the concentrations of the fluorine source gas satisfy the relation Q>0.14.

The contents of the following Japanese patent application is incorporated herein by reference:

NO. 2011-052634 filed on Mar. 10, 2011.

### BACKGROUND

1. Technical Field

The present invention relates to a method of manufacturing a fluorine-containing optical fiber base material and a fluorine-containing optical fiber base material thereof. More specifically, the invention relates to a method of manufacturing a glass base material for an optical fiber in which fluorine is evenly added in its radial direction, in particular, to a method of manufacturing a fluorine-containing optical fiber base material in which variation in relative refractive index difference Δ in the radial direction of the base material can be reduced, and a fluorine-containing optical fiber base material thereof.

2. Related Art

Optical fibers have a cladding which surrounds an outer surface of a core of the optical fiber propagating light to prevent light leakage therefrom. The core portion has a higher refractive index than that of the cladding portion. Characteristics of optical fibers are defined by their refractive-index distributions. In order to obtain desired characteristics of an optical fiber, generally, germanium (Ge) which increases the refractive index or fluorine which lowers the refractive index are added to the optical fiber made of synthetic silica. One of techniques to add fluorine into optical fibers is performing a heat treatment under a fluorine compound gas atmosphere onto a porous glass stack which is formed by a VAD method or the like. After fluorine is added, the porous glass stack is further heated at a higher processing temperature in order to make the glass transparent, and then a fluorine-containing optical fiber base material is obtained.

However, when the outside diameter of the porous glass stack is large and/or a target density of fluorine added in the porous glass stack is high, the fluorine which has been added in the previous process can be desorbed or stripped when it is subjected to a high temperature during the heating process for making the stack into a transparent glass. As a result, the optical fiber base material would have an unequal concentration along its radial direction.

### SUMMARY

Therefore, it is an object of an aspect of the innovations herein to provide a method for manufacturing a fluorine-containing optical fiber base material in which fluorine can be added evenly along a radial direction and variation in relative refractive index difference Δ in the radial direction can be reduced, and to provide such fluorine-containing optical fiber base material, which are capable of overcoming the above drawbacks accompanying the related art.

In a first aspect of the innovations, it is an object of the invention to provide a method of manufacturing a fluorine-containing optical fiber base material and a fluorine-containing optical fiber base material thereof, which are capable of overcoming the above drawbacks accompanying the related art. The above and other objects can be achieved by combinations described in the claims. In the first aspect of the innovations, provided is a method of manufacturing a fluorine-containing optical fiber base material through a sintering process. The sintering process includes a first step in which a porous glass stack is dehydrated by heating the porous glass stack under a chlorine-based gas atmosphere, a second step in which fluorine is added into the porous glass stack by heating the porous glass stack under a fluorine source gas atmosphere, and a third step in which the porous glass stack is made transparent by heating the porous glass stack at a higher temperature than the second step under a fluorine source gas atmosphere. Here, process temperatures in the first, second and third steps are T₁, T₂ and T₃ (K) respectively, concentrations of the fluorine source gas in the second and third steps are C₂ and C₃ (%) respectively, a parameter Q is represented by the formula Q=C₂×exp(−T₂/T₁)+C₃×exp(−T₂/T₁), and the process temperatures and the concentrations of the fluorine source gas satisfy the relation Q>0.14.

In a second aspect of the innovations, the concentration C₂ of the fluorine source gas in the second step may be equal to or above the concentration C₃ of the fluorine source gas in the third step.

In a third aspect of the innovations, the process temperature T₁ in the first step may be equal to or above the process temperature T₂ in the second step.

In a fourth aspect of the innovations, a value of the parameter Q may be 0.27 or greater.

A fifth aspect of the innovations may provide a fluorine-containing optical fiber base material manufactured by the above-described manufacturing method, and a coefficient of variation (standard deviation/arithmetic average) for relative refractive index difference Δ in a radial direction of a fluorine-added layer with respect to a level of quartz is 0.03 or smaller.

The summary clause does not necessarily describe all necessary features of the embodiments of the present invention. The present invention may also be a sub-combination of the features described above.

### BRIEF DESCRIPTION OF THE DRAWINGS

FIG. 1 is a graph showing a relationship between a value of a parameter Q and a coefficient of variation for relative refractive index difference Δ of a fluorine added layer.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

According to an aspect of the invention, a manufacturing method for an optical fiber base material includes a sintering process including a first step in which a porous glass stack is dehydrated using a chlorine-based gas, a second step in which fluorine is added, and a third step in which the glass is made transparent under a gas atmosphere containing a fluorine source, in order to obtain a fluorine-containing optical fiber base material. The fluorine-containing optical fiber base material is manufactured at process temperatures and fluorine-source gas concentrations with which a parameter Q in the formula Q=C₂×exp(−T₂/T₁)+C₃×exp(−T₂/T₁) satisfies Q>0.14, where T₁, T₂ and T₃ (K) are process temperatures for the first, second and third steps respectively, and C₂ and C₃ (%) are fluorine-source gas concentrations in the second and third steps respectively. The reason why a value of the parameter Q is set to the range Q>0.14 is that if Q is 0.14 or less, a coefficient of variation for the relative refractive index difference Δ of the fluorine added layer along its radial direction will exceed 0.03 and an optical fiber with fine optical characteristics cannot be obtained.

Although fluorine addition to a porous glass stack and a process to make the glass transparent according to the invention will be hereunder described in conjunction with examples and comparative examples, it should be understood that the present invention is not limited to such examples but various embodiments are possible.

### Example 1

A porous glass stack was first inserted in a furnace core tube and placed above a heater. The glass stack was heated to 1100° C. (1373K) and then Cl₂ as a chlorine-based gas was introduced along with an inert gas (He) into the furnace core tube. The porous glass stack was gradually moved downward from above the heater to dehydrate the porous glass stack from its lower end (the first step). The porous glass stack was again placed over the heater, the temperature was maintained at 1100° C., and an inert gas (Fe) and a fluorine compound gas (SiF₄; 0.75%) was introduced into the furnace core tube. The porous glass stack was then gradually moved downward from above the heater to add fluorine therein (the second step).

Again the porous glass stack was placed above the heater, the temperature was raised to 1420° C. (1693K) at which the porous glass stack can be made transparent. An inert gas (He) and a fluorine compound gas (SiF₄; 0.30%) were subsequently introduced into the furnace core tube, and the porous glass stack was then gradually moved downward from above the heater to make the glass stack transparent while adding fluorine therein (the third step). A value of Q which was calculated from the formula Q=C₂×exp(−T₂/T₁)+C₃×exp(−T₂/T₁) was 0.41 in this example. According to such method, the fluorine compound gas was introduced also in the third step so that desorption and stripping of the fluorine added in the second step could be controlled even though the porous glass stack was subjected to the high temperature to obtain the transparent glass. As a result, a coefficient of variation (standard deviation/arithmetic average) for the relative refractive index difference Δ along the radial direction of the fluorine added layer in the porous glass stack was 0.011.

### Examples 2 through 4

The process temperatures T₁, T₂ and T₃ (K) in the first, second and third steps and the fluorine-source gas concentrations C₂ and C₃ (%) in the second and third steps were adequately set such that a value of Q calculated from the formula Q=C₂×exp(−T₂/T₁)+C₃×exp(−T₂/T₁) satisfies Q>0.14. Fluorine was added to the porous glass stack and the porous glass stack was then made transparent in the same manner as the above Example 1 except for different values of Q. Process conditions for each example were shown in Table 1 below.

The fluorine-source gas concentration C₂ in the second step may be higher than the fluorine-source gas concentration C₃ in the third step. The process temperature T₁ in the first step may be higher than the process temperature T₂ in the second step.

Consequently, as shown in Table 1, a coefficient of variation for the relative refractive index difference Δ was below 0.03 in all of the examples.

TABLE 1

| | FIRST STEP | SECOND STEP | | THIRD STEP | | | COEFFICIENT |
|---|---|---|---|---|---|---|---|
| | TEMP. | TEMP. | SiF4 CONC. | TEMP. | SiF4 CONC. | PARAMETER Q | OF VARIATION |
| | (K) | (K) | (%) | (K) | (%) | (—) | (—) |
| EXAMPLE 1 | 1373 | 1373 | 0.75 | 1693 | 0.30 | 0.41 | 0.011 |
| EXAMPLE 2 | 1373 | 1373 | 1.25 | 1693 | 1.25 | 1.02 | 0.017 |
| EXAMPLE 3 | 1373 | 1373 | 1.25 | 1673 | 0.25 | 0.57 | 0.028 |
| EXAMPLE 4 | 1373 | 1323 | 0.50 | 1693 | 0.20 | 0.27 | 0.023 |

### Comparative Example 1 through 3

In Comparative Example 1 through 3, fluorine was added to the porous glass stack and the porous glass stack was made transparent in the same manner as the above Example 1 except for the sintering gas condition, in other words, a value of Q. Process conditions for each comparative example were shown in Table 2 below. In the comparative examples, values of Q were made smaller than the above examples, and consequently coefficients of variation for the relative refractive index difference Δ were above 0.03.

TABLE 2

| | | | | | | | COEFFICIENT |
|---|---|---|---|---|---|---|---|
| | FIRST STEP | SECOND STEP | | THIRD STEP | | | OF |
| | TEMP. | TEMP. | SiF4 CONC. | TEMP. | SiF4 CONC. | PARAMETER Q | VARIATION |
| | (K) | (K) | (%) | (K) | (%) | (—) | (—) |
| COMPARATIVE | 1373 | 1373 | 0.25 | 1693 | 0.10 | 0.14 | 0.098 |
| EXAMPLE 1 | | | | | | | |
| COMPARATIVE | 1373 | 1373 | 0.25 | 1693 | 0.05 | 0.11 | 0.105 |
| EXAMPLE 2 | | | | | | | |
| COMPARATIVE | 1373 | 1323 | 0.15 | 1673 | 0.15 | 0.12 | 0.074 |
| EXAMPLE 3 | | | | | | | |

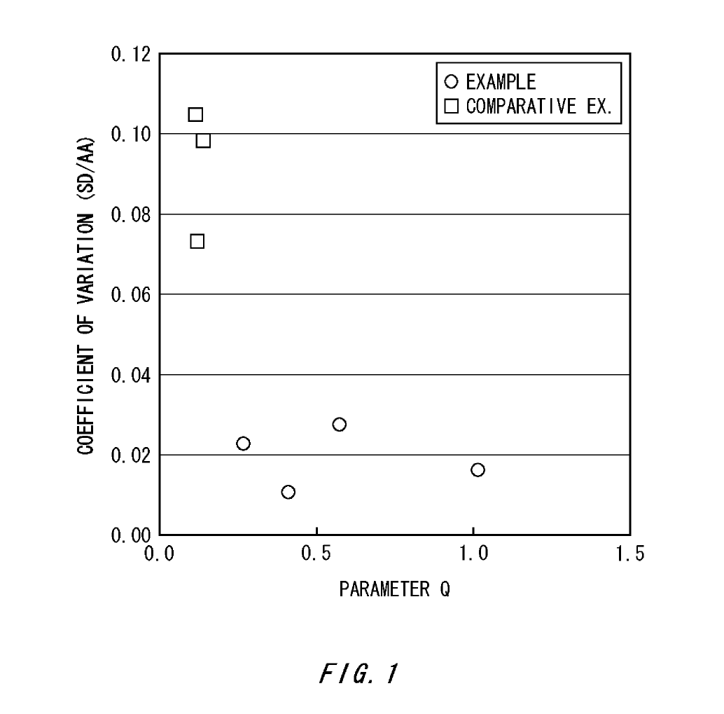

FIG. 1 illustrates a relationship between the values of Q and the coefficients of variation for the relative refractive index difference Δ. As shown in the above results, it was demonstrated that a fluorine-containing optical fiber base material with a small variation in relative refractive index difference Δ along the radial direction of its fluorine added layer could be manufactured by introducing a fluorine compound gas into the furnace core tube in the step of making the glass stack transparent after the step of fluorine addition, and setting a sintering condition such that a value of Q represented by the formula Q=C₂×exp(−T₂/T₁)+C₃×exp(−T₂/T₁) satisfies Q>0.14.

The sintering condition can also be set such that the value of the parameter Q is 0.27 or above in order to manufacture a fluorine-containing optical fiber base material with a small variation in relative refractive index difference Δ along the radial direction of its fluorine added layer.

In this way, it is also possible to manufacture a fluorine-containing optical fiber with a small variation in relative refractive index difference Δ along the radial direction of its fluorine added layer.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As described above, according to the embodiments of the invention, even when an outer diameter of the porous glass stack is large and/or a target fluorine adding concentration is high, it is possible to realize a manufacturing method for a fluorine-containing optical fiber base material with a very small variation coefficient (standard deviation/arithmetic average) for relative refractive index difference Δ along the radial direction of its fluorine added layer, and a fluorine-containing optical fiber base material thereof.

What is claimed is:

1. A method of manufacturing a fluorine-containing optical fiber base material through a sintering process, the sintering process comprising;
dehydrating a porous glass stack by heating the porous glass stack under a chlorine-based gas atmosphere;
adding fluorine into the porous glass stack by heating the porous glass stack under a fluorine source gas atmosphere; and
making the porous glass stack transparent by heating the porous glass stack under a fluorine source gas atmosphere at a higher temperature than a temperature at which the porous glass stack is heated in the adding, wherein
process temperatures in the dehydrating, adding and making are T₁, T₂ and T₃ (K) respectively, concentrations of the fluorine source gas in the adding and making are C₂ and C₃ (%) respectively, a parameter Q is represented by the formula:
Q=C2×exp(−T₂/T₁)+C₃×exp(−T₂/T₁),
and the process temperatures and the concentrations of the fluorine source gas satisfy the relation Q>0.14.

2. The method of manufacturing a fluorine-containing optical fiber base material according to claim 1, wherein
the concentration C₂ of the fluorine source gas in the adding is equal to or above the concentration C₃ of the fluorine source gas in the making.

3. The method of manufacturing a fluorine-containing optical fiber base material according to claim 2, wherein
the process temperature T₁ in the dehydrating is equal to or above the process temperature T₂ in the adding.

4. The method of manufacturing a fluorine-containing optical fiber base material according to any one of claim 1, wherein a value of the parameter Q is 0.27 or greater.

5. A fluorine-containing optical fiber base material manufactured by the method according to claim 1, wherein a coefficient of variation (standard deviation/arithmetic average) for relative refractive index difference Δ in a radial direction of a fluorine-added layer with respect to a level of quartz is 0.03 or smaller.
